(19) United States
(12) Patent Application Publication
(10) Pub. No.: US 2026/0127143 A1
(43) Pub. Date: May 7, 2026

(54) RAPID DATABASE SIZING USING METADATA

(71) Applicant: State Farm Mutual Automobile Insurance Company, Bloomington, IL (US)

(72) Inventor: Eugene Scray, Bloomington, IL (US)

(21) Appl. No.: 18/592,496

(22) Filed: Feb. 29, 2024

(51) Int. Cl. G06F 16/21; G06F 16/2458; G06F 16/248; G06F 16/27

(52) U.S. Cl. CPC G06F 16/21; G06F 16/2468; G06F 16/248; G06F 16/27

(57) ABSTRACT

Described herein are systems and techniques to facilitate a rapid database system that automates estimating a database footprint for a database implemented across multiple environments. The system may receive inputs from a user and/or automatically generate inputs. The system may determine database size using various logic-based extraction methods. For instance, operational database resources may be sized using logic-based extraction to search a database catalog of a production database, non-production databases may be sized using logic-based extraction to search database catalog metadata, development database resources may be sized using fuzzy logic queries generated based on production database information (e.g., since development database names are likely to resemble, but be different than, production database names), and associated mirror databases are also determined and measured during these steps. Outputs from the queries are used to generate a database footprint estimate and cost information, which may be transmitted to a user device for display.

### BACKGROUND

Large organizations may maintain many databases implemented across multiple different physical computing resources. There are often many different copies and versions of such databases maintained in testing environments, production environments, and non-production environments for a variety of purposes, such as redundancy, backup, development, testing, and production use. As an example, a large organization may have a particular database maintained in a production environment with versions replicated across multiple production and non-production environments. Within each environment, mirrors (e.g., copies) of the particular database can be maintained for various purposes. Accordingly, across all the environments, thousands of instances of the particular database can be maintained. Therefore, determining the true footprint of a particular database (e.g., quantity and cost of computing resources used by the database, including all related types and versions of that database) can be a complex task involving many different factors.

Currently, estimating a database footprint is a largely manual process. In particular, in current techniques, a user must manually estimate values associated with allocated, used, and unused resources in various environments. The user must then estimate a total database footprint then estimated by a user. This is not only time and labor intensive, but often results in an inaccurate database footprint estimate. Inaccurate database footprint estimates may impact computing resource management and planning, ultimately affecting production services. For instance, inaccurate database footprints may result in an organization paying for space that they do not need. Inaccurate database footprint estimates may also result in a company purchasing too little of space, resulting in reliability problems. Further, inaccurate database footprint estimates result in companies lacking an accurate cost accounting of database use, leading to inefficient and ineffective infrastructure management.

Moreover, while some techniques enable other data to be pulled (e.g., by scanning tables), doing so may take an extended amount of time (e.g., days, weeks, months, etc.). This is not only labor intensive and costly, but current techniques do not consider mirrors, unused and unallocated space, and more, and thus, still result in inaccurate database footprint estimates.

The examples of the present disclosure are directed to overcoming these deficiencies and providing a way to accurately and efficiently size a complex database system.

### SUMMARY

Techniques described herein are directed to providing a streamlined and accurate determination of a true footprint of a complex database system. Techniques described herein implement a rapid database sizing system that automates estimating a database footprint for a database implemented across multiple environments and/or in multiple geographically dispersed computing resources. The system generates a database sizing interface with various controls and interface elements that accept parameters from a user to be used in identifying and sizing database resources. Automated processing is then executed based on these parameters to perform the various measurements required to determine the sizing of various types of database resources. These processes will vary depending on the type of resource being sized. For example, operational database resources may be sized using logic-based extraction to search a database catalog of a production database administration service, while non-production databases may be sized using logic-based extraction to search database catalog metadata (i.e., outside of a database administration service). Development database resources may be sized using fuzzy logic queries generated based on production database information (e.g., since development database names are likely to resemble, but be different than, production database names). Associated mirror databases are also determined and measured during these steps. Further processes are used to determine a ratio of the development database sizes to the production database sizes and allocated space to used space.

Based on the determined sizing data, an algorithm that integrates a pricing parameter (may be provided in the initial user-provided parameters) may be executed to determine a cost of maintaining the database, including a cost per unit of data storage resources. The resulting database footprint data may be provided to the user on the same or an updated interface. The algorithm used to perform the footprint calculation may vary and the inputs may be weighted or otherwise adjusted based on various criteria.

For example, the techniques described herein may relate to a method for determining, by a processor of a database storage system, first data comprising an average size of a database type associated with one or more first databases in a first environment; determining, by the processor, second data comprising a second average database size of the database type for one or more second databases in a second environment; determining, by the processor, third data associated with the database type for one or more third databases in a third environment; determining, by the processor, fourth data comprising an indication of redundancy of the database type across the first environment, the second environment, and the third environment; determining, by the processor, a ratio between physical space and unallocated and unused space for each database of the database type; generating, by the processor and based on one or more of the first data, the second data, the third data, the fourth data, and the ratio, result data; and transmitting, by the processor, the result data to a user device for display via a user interface.

In further examples, the techniques described herein may relate to non-transitory computer-readable medium comprising instructions that, when executed by one or more processors of a database storage system, cause the one or more processors to determine first data comprising an average size of a database type associated with one or more first databases in a first environment; determine second data comprising a second average database size of the database type for one or more second databases in a second environment; determine third data associated with the database type for one or more third databases in a third environment; determine fourth data associated with a fourth environment, the fourth environment including the first environment, the second environment, and the third environment; generate, based on one or more of the first data, the second data, the third data, and the fourth data, result data; and transmit the result data to a user device for display via a user interface.

In additional examples, the techniques described herein may relate to a database storage system that may include one or more processors and a non-transitory memory storing computer-executable instructions that, when executed, cause the one or more processors to perform operations comprising: determine first data comprising an average size of a database type associated with one or more first databases in a first environment; determine second data comprising a second average database size of the database type for one or more second databases in a second environment; determine third data associated with the database type for one or more third databases in a third environment; determine fourth data comprising an indication of redundancy of the database type across the first environment, the second environment, and the third environment; determine a ratio between physical space and unallocated and unused space for each database of the database type; generate, based on one or more of the first data, the second data, the third data, the fourth data, and the ratio, result data; and transmit the result data to a user device for display via a user interface.

Further examples described herein may relate to a system for generating database footprint estimate that may include means for determining first data comprising an average size of a database type associated with one or more first databases in a first environment; means for determining second data comprising a second average database size of the database type for one or more second databases in a second environment; means for determining third data associated with the database type for one or more third databases in a third environment; means for determining fourth data associated with a fourth environment, the fourth environment including the first environment, the second environment, and the third environment; means for generating, based on one or more of the first data, the second data, the third data, and the fourth data, result data; and means for transmitting the result data to a user device for display via a user interface.

### BRIEF DESCRIPTION OF THE DRAWINGS

FIG. 1 illustrates an example environment in which rapid database sizing systems and methods may be implemented.

FIG. 2 is a diagram of example inputs and outputs associated with the rapid database sizing system according to the examples described herein.

FIG. 3A is a diagram of example inputs, processing, and outputs in association with a target according to the examples described herein.

FIG. 3B is a pictorial flow diagram illustrating an example process for extracting metadata according to the examples described herein.

FIG. 4 is an exemplary user interface that may be displayed according to the examples described herein.

FIG. 5 is a pictorial flow diagram illustrating an example process according to the examples described herein.

FIG. 6 shows an example system architecture for a computing device that may be used to implement the systems and architectures described herein.

The detailed description is set forth with reference to the accompanying figures. In the figures, the left-most digit(s) of a reference number identifies the figure in which the reference number first appears. The use of the same reference numbers in different figures indicates similar or identical items.

### DETAILED DESCRIPTION

Certain implementations and examples of the disclosure will now be described more fully below with reference to the accompanying figures, in which various aspects are shown. However, the various aspects may be implemented in many different forms and should not be construed as limited to the implementations set forth herein. The disclosure encompasses variations of the examples, as described herein. Like numbers refer to like elements throughout.

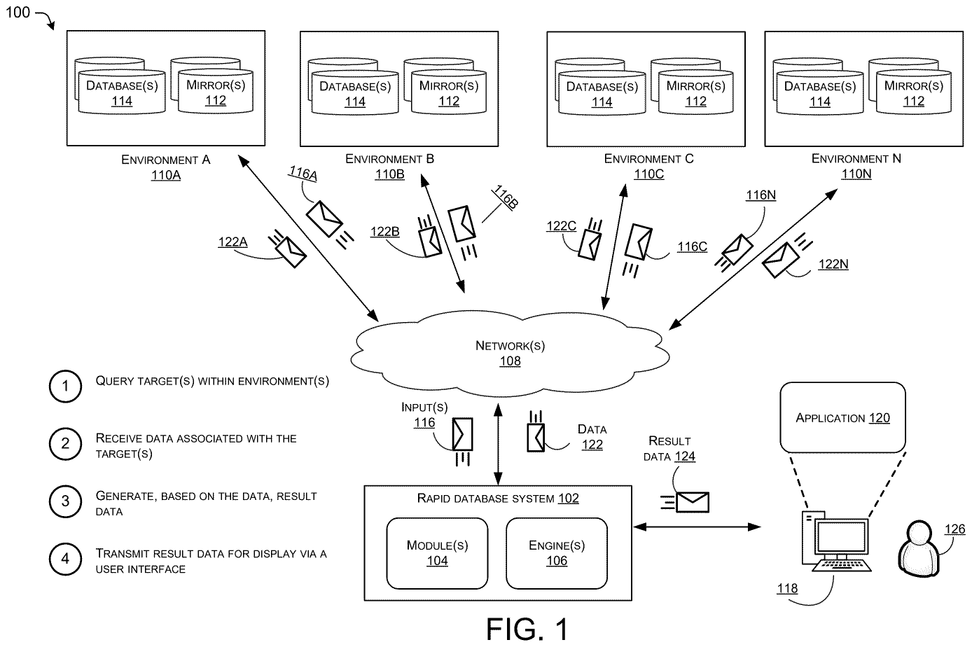

FIG. 1 illustrates an environment 100 in which a rapid database sizing system may be implemented according to examples of the instant disclosure. While the environment 100 illustrates a system associated with a rapid database sizing of servers, the techniques may apply to any file server mechanism and/or data storage mechanism (e.g., cloud storage system, etc.)

A rapid database system 102 may be operated by or on behalf of an organization that may provide goods and/or services to users (e.g., customers) and/or may otherwise interact with users of user devices capable of communications via network(s) 108. In some examples, the rapid database system 102 is integrated as part of a product associated with an organization (e.g., such as a centralized database repository system or any mainframe system).

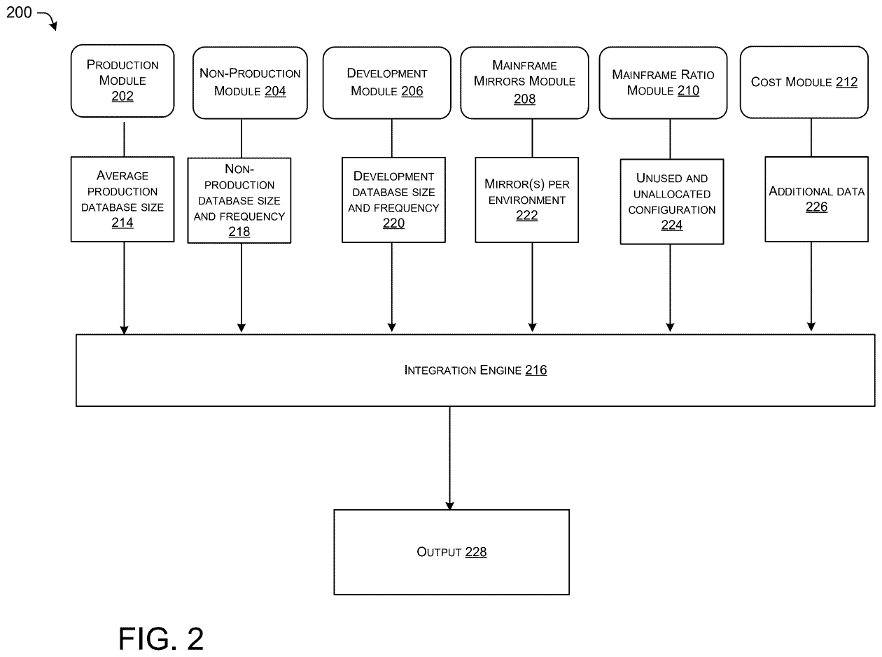

The rapid database system 102 may include one or more module(s) 104 configured to perform the exemplary operations described herein. A “module” as used herein may include a hardware component, a software component, a component including both hardware and software, a software and/or hardware function of any type, a device of any type, a system of any type, and any combination thereof. Module(s) 104 may include production module 202, non-production module 204, development module 206, mainframe mirrors module 208, mainframe ratio module, 210, and/or cost module 212, as described in greater detail in FIG. 2 below.

The rapid database system 102 may include one or more engine(s) 106 configured to perform exemplary operations described herein. Engine(s) 106 may correspond to integration engine 216, as described in greater detail in FIG. 2 below. Engine(s) 106 may store one or more algorithm(s) that can be used to perform exemplary operations described herein. For instance, algorithm(s) may include fuzzy logic, composite algorithm(s), machine-learning algorithm(s), etc. Engine(s) 106 may utilize one or more of the algorithm(s) when generating result data 124.

In some examples, the module(s) 104 and/or the engine(s) 106 can be configured to train models using machine-learning mechanisms. For example, a machine-learning mechanism can analyze training data to train a data model that generates an output, which can be result data 124, graphs, user interfaces, recommendations, etc. The rapid database system 102 may generate training data using historical data associated with database sizing. For instance, the training data may include past footprints determined by the system, input(s) received from a user 126, etc. The rapid database system 102 may update the training data and re-train the machine-learning algorithms after a true footprint estimate has been generated and/or using feedback from a user 126.

Machine-learning algorithms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in memory of the rapid database system 102 for use at a time after the data models have been trained (e.g., at runtime).

A user 126 may be operating a user device 118 that may be any type of communications device capable of communicating using one or more communications channels. For example, user device 118 may be a telephone, a smartphone, a wireless communications device of any other type, a desktop computer, a laptop computer, a tablet computer, a computer of any other type, etc. In a particular example, user device 118 may be a laptop capable of communicating and/or interacting with one or more remote devices or systems using one or more communications channels, such as voice communications, messaging communications (e.g., text and/or multimedia messaging), and/or via an application (e.g., messaging within a social network application or a social media application).

User device 118 may include application 120. Application 120 may be configured to enable the user 126 to access the rapid database system 102. For instance, application 120 may generate and display a user interface that enables a user 126 to provide one or more input(s) 116. Input(s) 116 may comprise one or more query parameters, such as a database name of interest, target environment(s) (e.g., logical partition(s) (LPARs) within a particular environment, LPARs within all environments, Mainframe Environment, etc.), amplification of the database name to include fuzzy logic (e.g., wild cards before, inside, and after the database name), and/or database catalog metadata as the catalog metadata exists on a mainframe associated with the environments. In some examples, input(s) 116 may be generated automatically by the rapid database system 102, such that a user 126 may provide minimal information (e.g., name of database) when requesting a database footprint estimate. In some examples, input(s) 116 may be sent as queries, using logic. For instance, the queries may be sent using SQL or any other suitable logic.

Rapid database system 102 may be configured to communicate via network(s) 108. The network 108 may include one or more networks implemented by any viable communication technology, such as wired and/or wireless modalities and/or technologies. The network 108 may include any combination of Personal Area Networks (PANs), software defined cloud interconnects (SDCI), Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs)-both centralized and/or distributed, software defined WANs (SDWANs)-and/or any combination, permutation, and/or aggregation thereof. The network 108 may include devices, virtual resources, or other nodes that relay packets from one network segment to another by nodes in the computer network. The network 108 may include multiple devices that utilize the network layer (and/or session layer, transport layer, etc.) in the OSI model for packet forwarding, and/or other layers.

Rapid database system 102 may be configured to communicate with one or more environments (illustrated as Environment A 110A, Environment B 110B, Environment C 110C, and/or Environment N 110N). Each of the one or more environments (e.g., production, non-production, development, mainframe, test, performance test, model office, etc.) may be located at a different physical location. In some examples, each of the environments may comprise a plurality of environments. For instance, a non-production environment may encompass a test environment, a performance test environment, a model office environment, or any other suitable environment. Accordingly, it is understood that each environment described herein is not limited to one environment and/or the examples described herein. For instance, Environment A 110A may be located in a first State within the United States, Environment B 110B may be located within a second State within the United States, and Environment C 110C may be located within a third State within the United States. In some examples, Environment A 110A may represent a production environment, Environment B 110B may represent a non-production environment, Environment C 110C may represent a development environment, and Environment N 110N may represent a mainframe environment of an organization. In some examples, Environment C 110C may be included as part of Environment B 110B and/or Environment A 110A. For instance, where Environment C 110C represents a development environment, one or more of the database(s) 114 and/or mirror(s) 112 of Environment C 110C may be located within a production environment and/or a non-production environment. Each environment may also include a direct access storage device (DASD) mainframe. In some examples, Environment N 110N corresponds to a mainframe environment of an organization. In this example, Environment N 110N includes and/or has access to data associated with the database(s) 114 and mirror(s) included in Environment A 110A, Environment B 110B, and Environment C 110C.

As illustrated, each of the one or more environments may include one or more database(s) 114. Database(s) 114 may comprise physical server(s) and/or virtual server(s). Database(s) 114 may be configured to operate any operating system (e.g., such as UNIX, LINUX, Windows, etc.). In some examples, database(s) 114 may comprise DB2 z/OS. In some examples, database(s) 114 may include an index (e.g., a portion of allocated memory) and a base (e.g., a portion of memory allocated to functionalities to allow the database to run). Database(s) 114 may further include a portion of memory associated with used and allocated data and a portion of memory associated with unused and unallocated data.

Each of the one or more environments may include one or more sets of mirror(s) 112. Each mirror may comprise one or more database(s) or servers, and may be physical, virtual, or a combination of physical and virtual. Mirror(s) 112 may correspond to one or more instances (e.g., copies) of database(s) 114 associated with each particular environment. For instance, mirror(s) 112 may include copies of production database(s) 114A associated with Environment A 110A, copies of performance databases associated with Environment B 110B, copies of development databases associated with Environment C 110C, etc. Mirror(s) 112 may be utilized by an organization for redundancy purposes (e.g., such that if a database in Environment A 110A, Environment B 110B, and/or Environment C 110C should fail, the mirror can be used to continue to provide service). Mirror(s) 112 may be located in several different geographic locations across the United States. Mirror(s) 112 may be updated in near real-time, across all copies of the databases. For instance, where a database in Environment A 110A is updated, all of the mirror(s) 112 of that database may be updated in real-time. Mirror(s) 112 may be located at a different location from the one or more environments.

As illustrated, the one or more environment(s) may be configured to communicate with the rapid database system 102. The rapid database system 102 may send one or more input(s) 116 to the one or more environment(s). For instance, the rapid database system 102 may send input 116A to Environment A 110A, input 116B to Environment B 110B, input 116C to Environment C 110C, and/or input 116N to Environment N 110N.

The rapid database system 102 may receive data 122 from the one or more environment(s). For instance, the rapid database system 102 may receive data 122A from Environment A 110A, data 122B from Environment B 110B, data 122C from Environment C 110C, and/or data 122N from Environment N 110N. In some examples, the rapid database system 102 may receive data 122 in response to sending input(s) 116. Data 122 may comprise metadata extracted from a database catalog and/or a mainframe of an environment. For instance, the database catalog may be associated with a mainframe of the particular environment and/or of a particular database or logical partition (LPAR) within an environment. In some examples, the data 122 comprises one or more of an average production database size of the target database from Environment A 110A, a non-production database size and frequency of the target database from Environment B 110B, a development database size and frequency of the target database from Environment C 110C, a number of mirror(s) of the target database within each environment (e.g., Environment A 110A, Environment B 110B, Environment C 110C, etc.), a ratio of unused and unallocated space associated with the target database across all environments, etc. In some examples, the rapid database system 102 may additionally receive cost information. For instance, the cost information may be input by user 126 via application 120.

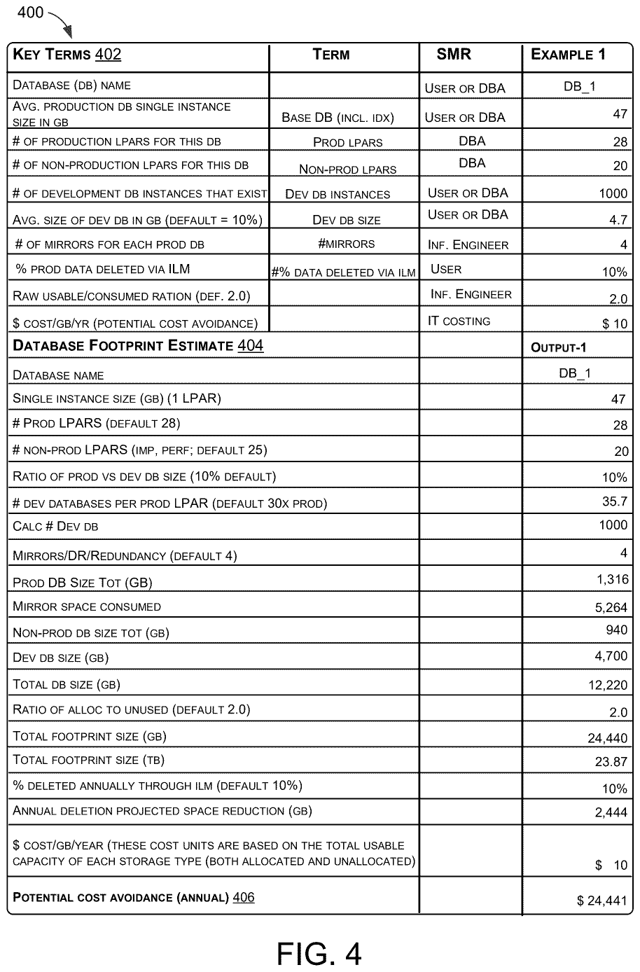

The rapid database system 102 may generate and output result data 124 to user device 118. Result data 124 may be based in part on data 122 and/or input(s) 116. Result data 124 may be generated using module(s) 104 and/or engine(s) 106. In some examples, result data 124 comprises a database footprint estimate. In some examples, result data 124 further comprises cost data and an estimated savings. In some examples, result data 124 comprises instructions to generate a user interface, such as the user interface 400, described in FIG. 4 below.

At “1”, the rapid database system 102 may query target(s) within environment(s). For instance, the rapid database system 102 may identify a target (e.g., a target database and/or a target LPAR) within Environment A 110A. The target database may be based on input(s) 116 received from user device 118. For instance, the target database may be based on a database name provided as part of input(s) 116. The rapid database system 102 may generate a query that includes input(s) 116. For instance, the query may comprise one or more query parameters, such as a database name of interest, target environment(s) (e.g., logical partition(s) (LPARs) within Environment A 110A, LPARs within all environments, mainframe environment (Environment N 110N), etc.), amplification of the database name to include fuzzy logic (e.g., wild cards before, inside, and after the database name), and/or database catalog metadata as the catalog metadata exists on a mainframe associated with each of the environments.

At “2”, the rapid database system 102 may receive data associated with the target(s). For instance, the rapid database system 102 may receive data 122 from the one or more environment(s). In some examples, the data comprises metadata extracted from a database catalog. For instance, the rapid database system 102 may receive data comprising one or more of an average production database size of the target database from Environment A 110A, a non-production database size and frequency of the target database from Environment B 110B, a development database size and frequency of the target database from Environment C 110C, a number of mirror(s) of the target database within each environment (e.g., Environment A 110A, Environment B 110B, and Environment C 110C), a ratio of unused and unallocated space associated with the target database, etc. In some examples, the rapid database system 102 may additionally receive cost information. For instance, the cost information may be input by user 126 via application 120.

At “3” the rapid database system 102 may generate, based on the data, result data. For instance, the rapid database system 102 may generate result data 124. Result data 124 may be generated using module(s) 104 and/or engine(s) 106. In some examples, result data 124 comprises a database footprint estimate. In some examples, result data 124 further comprises cost data and an estimated savings. In some examples, result data 124 comprises instructions to generate a user interface, such as the user interface 400, described in FIG. 4 below.

At “4”, the rapid database system 102 may transmit the result data for display via a user interface. For instance, the rapid database system 102 may transmit the result data to application 120.

By utilizing a rapid database system, the techniques described herein provide a faster and more accurate way to determine a database footprint. That is, by identifying data duplicity in production databases, correlated data duplicity in non-production environments, related data duplicity in all development environments, mirrors for redundancy, allocated and unused space, and/or cost per unit of raw storage, the described techniques provide an accurate database footprint estimate, thereby improving database management systems. Unlike existing techniques that could take months to generate a database footprint estimate, the current techniques may generate an estimate in minutes that is more accurate than previous techniques. Moreover, by integrating cost with the database footprint, the rapid database system enables correlation of data that previously was time intensive, costly, and difficult to obtain. Further, by generating detailed results data, areas of data can be identified for archiving (as part of information lifecycle management) in a more efficient manner, resulting in a reduced footprint size of the database, as well as cost savings to users.

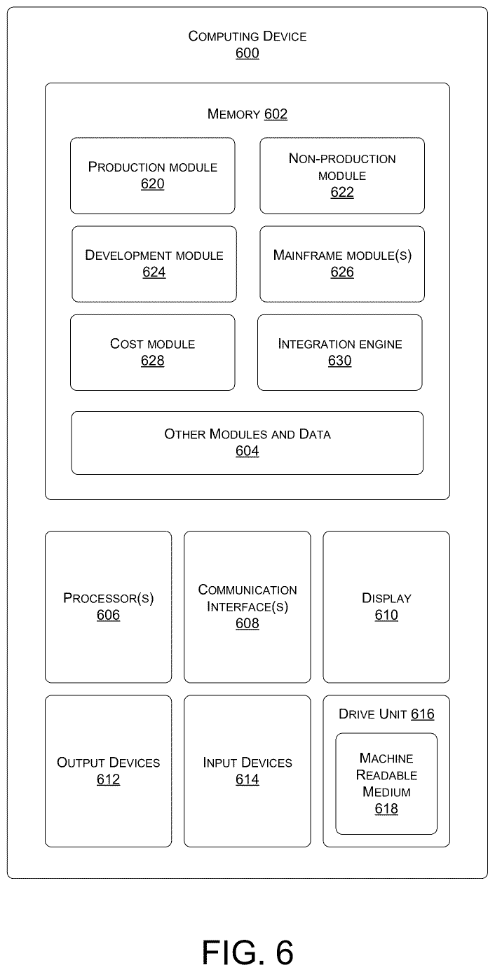

FIG. 2 is a diagram 200 of example inputs and outputs associated with the rapid database sizing system according to the examples described herein. In examples, one or more operations and signals of the diagram 200 may be implemented by a rapid database system 102, such as by using one or more of the components and systems illustrated in FIG. 1 and described above and/or by using one or more of the modules and systems illustrated in FIG. 6 and described below. For example, reference may be made in this description of the diagram 200 to devices, entities, functions, components, and/or interfaces illustrated in FIG. 1 and described in regard to that figure, including one or more components and systems associated with the rapid database system 102. One or more such components and systems can also, or instead, include those associated with the computing device 600 illustrated in FIG. 6. In other examples, one or more operations and signals of the diagram 200 may be implemented by a combination of components described in regard to these systems and/or other systems. However, the operations of diagram 200 is not limited to being implemented by such components and systems, and the components and systems described herein are not limited to implementing the operations of diagram 200.

As illustrated in FIG. 2, the diagram 200 may include a production module 202, non-production module 204, development module 206, mainframe mirrors module 208, mainframe ratio module 210, and/or cost module 212. Diagram 200 may include additional module(s) or fewer module(s), and is not limited to the module(s) shown.

Production module 202 may be configured to receive and/or generate input. Production module 202 may communicate with a production environment, such as Environment A 110A within a large organization. For instance, the production module 202 may receive input identifying a target. In some examples, the target may correspond to a target database. The production module 202 may generate additional input to send to the production environment. For instance, the additional input may comprise one or more of query parameters specifying a production database name, a target production environment (e.g., a target logical partition (LPAR), or target interest (e.g., all production LPARs)), and/or a database catalog metadata as it exists on a database mainframe in the target production environment (e.g., such as DB2 Catalog Metadata on a ZPOD DB2 Mainframe in each and all target production environments). Production module 202 may query the production environment and may receive production data in response. In some examples, the production module 202 may output the production data to integration engine 216. For instance, the production data may comprise an average production database size 214. In some examples, the production data may comprise metadata extracted from one or more database catalogs. For instance, the metadata may include an indication of space consumed by a target database for all production environments for the base database and the indices and/or a composite value indicating an average space consumed by each production environment and the number of production environments.

Non-production module 204 may be configured to receive and/or generate input in association with a non-production environment within a large organization. For instance, non-production module 204 may communicate with a non-production environment, such as Environment B 110B. The non-production module 204 may receive input identifying a target, such as a target database. In some examples, the non-production module may receive the input identifying the target from a user device or production module 202. For instance, production module 202 may receive the first input identifying the target. Production module 202 may output an average production database size 214 associated with the target within the production environment and may provide the non-production module 204 the target as input. Accordingly, a user 126 does not need to re-enter input for each environment.

The non-production module 204 may generate additional input to send to the non-production environment. For instance, the additional input may comprise one or more of query parameters specifying a non-production database name (excluding development environments), target non-production environments (e.g., target logical partitions (LPARs), or target interest (e.g., all non-production LPARs, excluding development environments)), and/or database catalog metadata as it exists on a database mainframe in the target production environment (e.g., such as DB2 Catalog Metadata on a ZPOD DB2 Mainframe in each and all target non-production environments (excluding development environments)). Non-production module 204 may query the non-production environment and may receive non-production data in response. In some examples, the non-production module 204 may output the non-production data to integration engine 216. For instance, the non-production data may comprise an average non-production database size and frequency 218. In some examples, the non-production data may comprise metadata extracted from one or more database catalogs associated with a mainframe and/or the non-production environments. For instance, the metadata may include an indication of space consumed by a target database for all non-production environments for the base database and the indices and/or a composite value indicating an average space consumed by each non-production environment and the number of non-production environments (excluding development environments).

Development module 206 may be configured to receive and/or generate input in association with development environments within a large organization. For instance, development module 206 may communicate with one or more development environments, such as Environment C 110C. The development module 206 may receive input identifying a target, such as a target database. In some examples, the development module 206 may receive the input identifying the target from a user device, production module 202, and/or non-production module 204. For instance, production module 202 may receive the first input identifying the target database of interest. Production module 202 may output an average production database size 214 associated with the target within the production environment and may provide the development module 206 the target database name as an input. In some examples, a user 126 may provide the input specifying the development environment database name of interest. In some examples, the development module 206 may generate the input automatically and without user input.

The development module 206 may generate additional input to send to the development environment. For instance, the additional input may comprise one or more of query parameters specifying the development environment (LPARs) database name of interest, amplification of the target database name to include fuzzy logic (e.g., wildcards before, inside, and/or after the target database name), the target development environments (e.g., target logical partitions (LPARs), or target interest (e.g., all development LPARs), and/or database catalog metadata as it exists on a database mainframe in the target development environment (e.g., such as DB2 Catalog Metadata on a ZPOD DB2 Mainframe in each and all target development environments). In some examples, the development module 206 employs fuzzy logic to automatically search from database names and/or targets that are similar to production database(s) and/or non-production database(s). Development module 206 may query the development environments and may receive development data in response. In some examples, the development module 206 may output the development data to integration engine 216. For instance, the development data may comprise an average development database size and frequency 220. In some examples, the development data may comprise metadata extracted from one or more database catalogs associated with a mainframe and/or the development environments. For instance, the metadata may include an indication of space consumed by the target database for all development environments for the base database and the indices and/or a composite value indicating an average space consumed by each development environment and the number of development environments.

Mainframe mirrors module 208 may be configured to receive and/or generate input in association with a mainframe environment (e.g., such as Environment N 110N) within a large organization. The mainframe environment may encompass all of the environments (e.g., Environment A 110A, Environment B 110B, Environment C 110C). For instance, mainframe mirrors module 208 may communicate with the mainframe environment to extract data and/or metadata associated with mirror(s) 112 and/or database(s) 114 across all the environments. The mainframe mirrors module 208 may receive and/or generate input comprising mainframe DASD query parameters. In some examples, the input may specify LPARs within the mainframe environment (e.g., all LPARs) and/or a target. In some examples, the mainframe mirrors module 208 may receive the input identifying the target (e.g., database name, LPARs, etc.) from production module 202, non-production module 204, development module 206, and/or a user 126.

Mainframe mirrors module 208 may query the mainframe environment and may receive mirror data in response. In some examples, the mainframe mirrors module 208 may output the mirror data to integration engine 216. For instance, the mirror data may comprise an indication of mirrors per environment 222. In some examples, the mirror data may comprise metadata extracted from a mainframe DASD configuration metadata within the mainframe environment. For instance, the metadata may include the quantity of mirrors associated with the environment and the target database. The metadata may further include an average number of mirrors across all environments (e.g., production, non-production, development, etc.).

Mainframe ratio module 210 may be configured to receive and/or generate input in association with a mainframe environment within a large organization. In some examples, mainframe mirrors module 208 and mainframe ratio module 210 may be included as part of a single mainframe module. As noted above, the mainframe environment may encompass all of environments 110 (e.g., Environment A 110A, Environment B 110B, Environment C 110C). The mainframe environment further includes mirror(s) 112. For instance, mainframe ratio module 210 may communicate with the mainframe environment to extract data and/or metadata associated with unallocated and unused space for each target database within each environment. The mainframe ratio module 210 may receive and/or generate input comprising mainframe DASD query parameters. In some examples, the input may specify a target database and/or one or more target LPARs within the mainframe environment (e.g., a single LPAR, all LPARs, etc.). In some examples, the mainframe ratio module 210 may receive the input identifying the target (e.g., database name, target LPAR, etc.) from production module 202, non-production module 204, development module 206, mainframe mirrors module 208, and/or a user 126.

Mainframe ratio module 210 may query the mainframe environment and may receive ratio data in response. In some examples, the mainframe ratio module 210 may output the ratio data to integration engine 216. For instance, the ratio data may comprise an unused and unallocated configuration 224. In some examples, the unused and unallocated configuration 224 includes a ratio between physical space and unallocated and unused space for each database sought after by the target LPAR across all environments.

Cost module 212 may be configured to communicate with application 120 described in FIG. 1 above and/or any other components of the environment 100. In some examples, a user 126 may provide input to the cost module 212 via application 120 and the cost module 212 may provide output to the integration engine 216. In some examples, the input may comprise cost information associated with the system. For instance, based on the input, the cost module 212 may output additional data 226 to the integration engine 216. The additional data 226 may comprise a cost per unit of raw storage, cost per raw unit of storage per year, etc.

Integration engine 216 is configured to receive input from one or more of the production module 202, non-production module 204, development module 206, mainframe mirrors module 208, mainframe ratio module 210, cost module and generate output 228. Integration engine 216 may generate output 228 using inputs from all of the module(s) and/or a subset of the module(s).

Integration engine 216 may store one or more algorithm(s) that can be used to perform exemplary operations described herein. For instance, algorithm(s) may include fuzzy logic, composite algorithm(s), machine-learning algorithm(s), etc. Engine(s) 106 may utilize one or more of the algorithm(s) when generating output 228.

In some examples, the integration engine 216 can be configured to train models using machine-learning mechanisms. For example, a machine-learning mechanism can analyze training data to train a data model that generates an output, which can be result data, graphs, user interfaces, recommendations, etc. The integration engine 216 may generate training data using historical data associated with database sizing. For instance, the training data may include past footprints determined by the rapid database system, input(s) received from a user 126, etc. The integration engine 216 may update the training data and re-train the machine-learning algorithms after a true footprint estimate has been generated and/or using feedback from a user 126.

Machine-learning algorithms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in memory of the integration engine 216 for use at a time after the data models have been trained (e.g., at runtime).

Integration engine 216 may provide output 228 to application 120. For instance, output 228 may correspond to result data 124 described in FIG. 1, and/or user interface 400, described in greater detail in FIG. 4 below. In some examples, output 228 comprises a database footprint estimate (e.g., database footprint size), footprint reduction and potential cost savings, and/or a cost associated with maintaining the database.

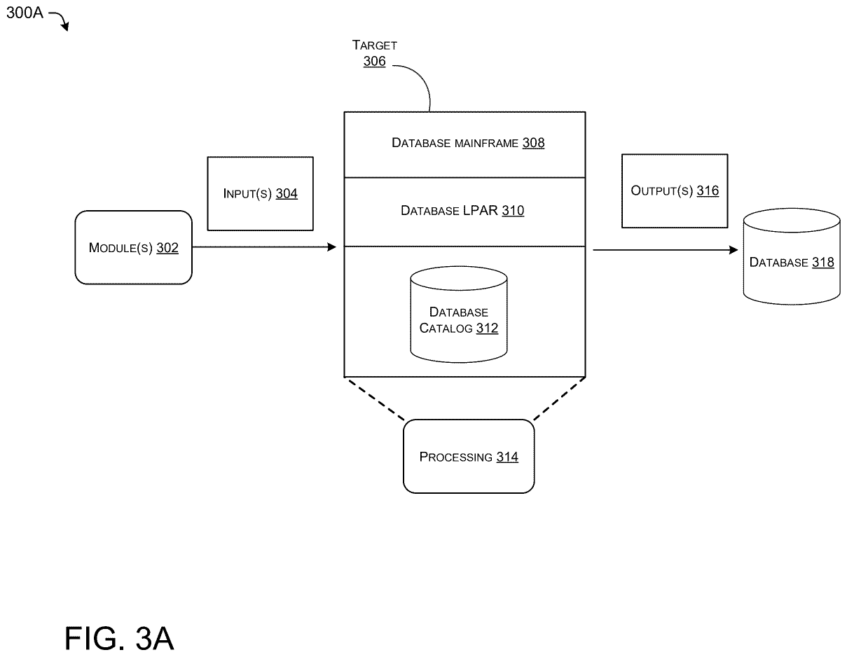

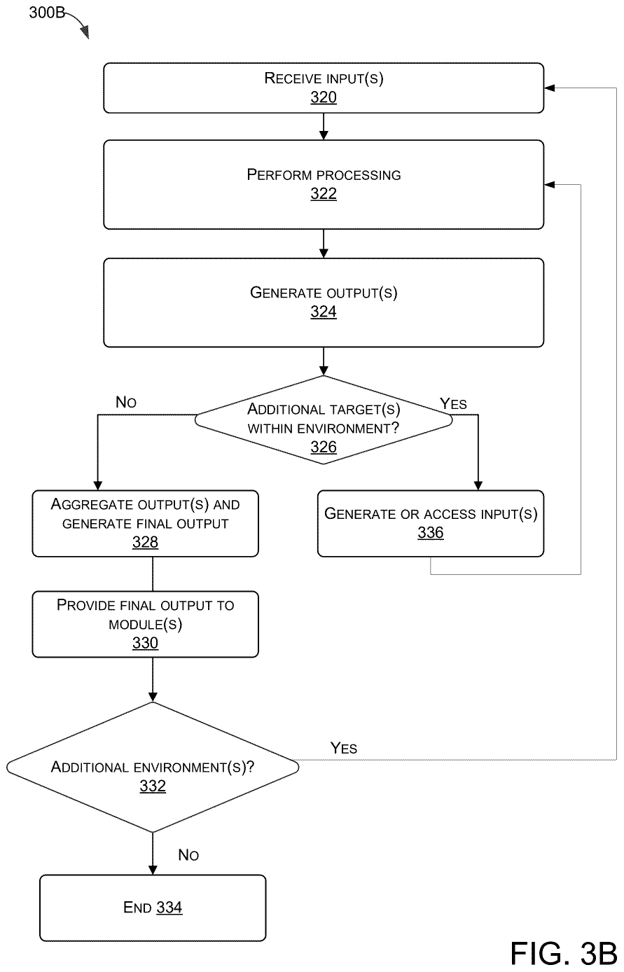

FIG. 3A is a diagram 300A of example inputs, processing, and outputs in association with a target according to the examples described herein. FIG. 3B is a pictorial flow diagram illustrating an example process 300B for extracting metadata using the example inputs, processing, and outputs described in FIG. 3A herein. In examples, one or more operations of FIG. 3A and/or FIG. 3B may be implemented by a rapid database system, such as by using one or more of the components and systems illustrated in FIG. 1 and described above and/or by using one or more of the components and systems illustrated in FIG. 6 and described below. One or more such components and systems can also, or instead, include those associated with the computing device 600 illustrated in FIG. 6. In other examples, one or more operations of diagram 300A may be implemented by a combination of components described in regard to these systems and/or other systems. However, the operations described in diagram 300A is not limited to being implemented by such components and systems, and the components and systems described herein are not limited to implementing the operations of diagram 300A.

Diagram 300A illustrates an example of inputs, processing, and outputs that may be exchanged and performed between rapid database system 102 and one or more environments. For instance, diagram 300A includes module(s) 302. Module(s) 302 may correspond to module(s) 104 of the rapid database system 102, described in FIGS. 1 and 2 above, and may include one or more of production module 202, non-production module 204, development module 206, mainframe mirrors module 208, mainframe ratio module 210, and/or cost module 212 described in FIG. 2 above.

Module(s) 302 may provide input(s) 304 to target 306. Input(s) 304 may correspond to input(s) 116 described in FIG. 1 and/or any of the inputs described in FIG. 2 above. For example, input(s) 304 may comprise one or more query parameters, such as a database name of interest, target environment(s) (e.g., logical partition(s) (LPARs) within a particular environment, LPARs within all environments, Mainframe Environment, etc.), amplification of the database name to include fuzzy logic (e.g., wild cards before, inside, and after the database name), and/or database catalog metadata as the catalog metadata exists on a mainframe associated with the environments. As described in FIGS. 1 and 2 above, the module(s) 302 may receive and/or generate input(s) 304. Module(s) 302 may send input(s) 304 to the target 306. For instance, module(s) 302 may query the target 306 using SQL or any other suitable code or logic.

Target 306 may correspond to a target database, a target LPAR, and/or the mainframe environment (e.g., Environment N 110N) indicated by input(s) 304. The target 306 may be a mainframe environment and/or may be a database or LPAR located within one or more environments (e.g., production, non-production, development, etc.). As illustrated in FIG. 3A, the target 306 may comprise a database mainframe 308, a database LPAR 310, and a database catalog 312. For instance, the database mainframe 308 may correspond to a ZOS mainframe, the database LPAR 310 may correspond to a ZOS DB2 LPAR, and the database catalog 312 may correspond to a DB2 catalog.

The target 306 may further perform processing 314 in response to receiving input(s) 304. For instance, where input(s) 304 are received from the production module 202, non-production module 204, and/or development module 206, the processing 314 may comprise performing steps that execute logic that (i) executes against the database catalog 312 to extract and retrieve an amount of space consumed by the target 306 as reported at the database catalog 312 metrics; (ii) formats the input(s) 304 into a consumable form external to this process; (iii) provides both base tablespace information and index consumption information associated with the target 306; and (iv) provides output(s) 316 to database 318. In this example, the output(s) 316 comprise a base space consumed by the target 306 and the index consumption information.

Where input(s) 304 are received from the mainframe mirrors module 208, processing 314 may comprise performing steps that execute logic that (i) executes against the DASD Extract I sufficient to retrieve the number of mirrors associated with the target 306 and (ii) formats the input(s) 304 into a consumable form external to this process.

Where input(s) 304 are received from the mainframe ratio module 210, processing 314 may comprise performing steps that execute logic that (i) executes against the mainframe configuration information sufficient to retrieve the ratio between allocated and unallocated space for the target 306 and (ii) formats the input(s) 304 into a consumable form external to this process.

As described in FIG. 3B below, the processing 314 may further comprise logic that performs the processing steps across all target(s) 306 within the environment, aggregates all output(s) 316 in the database 318, computes the average of the output(s) 318 (e.g., generates the average production database size 214, average non-production database size and frequency 218, average development database size and frequency, average mirror(s) per environment), and/or generates a ratio (e.g., average ratio between physical and unused and unallocated space (unused and unallocated configuration 224, described in FIG. 2 above).

FIG. 3B is a pictorial flow diagram illustrating an example process 300B for extracting metadata according to the examples described herein and in reference to FIG. 3A. One or more of the operations illustrated in FIG. 3B may be performed by a target 306 and/or one or more components of the rapid database system 102.

At 320, the process 300B may receive input(s). For instance, as described in FIG. 3A, the target 306 may receive input(s) 304 from module(s) 302.

At 322, the process 300B may perform processing. For instance, the target 306 may perform one or more processing steps as part of processing 314 the input(s) 304.

At 324, the process 300B may generate output(s). For instance, the target 306 may generate output(s) 316. Output(s) 316 may be stored in database 318. Database 318 may be included in an environment associated with the target 306. In some examples, database 318 may be included as part of rapid database system 102.

At 326, the process 300B may determine whether any additional targets exist. For instance, the process 300B may initially query a first target 306 within Environment A 110A. After receiving output from the first target, the process 300B may determine whether another target exists within Environment A 110A.

Where the process 300B determines that another target exists (operation 326—YES), the process 300B proceeds to 336. At 336, the process 300B generate(s) input(s). For instance, the process 300B may generate new input associated with the new target and/or access the input(s) 304 used previously. The process 300B then returns to step 322 to perform processing at the other target.

Where the process 300B determines that an additional target does not exist (operation 326—NO), the process 300B proceeds to 328. At 328, the process 300B aggregates all output(s) 316 received from the target(s) 304 and generates a final output. The final output may comprise data 122 described in FIG. 1 above. For instance, the final output may comprise the average of the output(s) 318 (e.g., generates the average production database size 214, average non-production database size and frequency 218, average development database size and frequency, average mirror(s) per environment), and/or generates a ratio (e.g., average ratio between physical and unused and unallocated space 224, described in FIG. 2 above).

At 330, the process 300B may provide the final output to module(s). For instance, production module 202 may receive the final output associated with the production environment.

At 332, the process 300B may determine whether there are additional environment(s) or mirror(s). For instance, where the process 300B initially queries the production environment and receives the final output from the production environment, the process 300B may determine whether there is another environment (e.g., non-production, development, mainframe, etc.) that the target 306 may be located within and/or if additional data and/or metadata associated with the target 306 needs to be collected.

Where the process 300B determines that an additional environment does exist (operation 332—YES), the process 300B returns to step 322 to perform processing 314 across the remaining environments.

Where the process determines that no additional environments exist (operations 332—NO), the process may proceed to 334, where the process 300B ends.

In this way, the techniques described herein may perform data extraction automatically with little to no user input, thereby streamlining database sizing technology. That is, unlike existing techniques that required manual input, could take months to gather all information, and resulted in inaccurate data, the current techniques can automatically identify and extract data in minutes that is more accurate than existing techniques.

FIG. 4 is an exemplary user interface 400 that may be displayed according to the examples described herein. In some examples, the user interface 400 corresponds to an example graphical user interface that can be displayed via application 120 on a computing device (e.g., user device 118) associated with a user 126. For instance, user interface 400 can be displayed as part of a centralized database repository system of an organization.

User interface 400 includes key terms 402. In some examples, the user interface 400 may enable the user to provide one or more of the key terms 402, such as the “database (db) name,” when initiating a database footprint estimate in accordance with the techniques described herein. In this example, the user may enter the database name “DB_1”. In response, and as described above, the rapid database system 102 may automatically generate input(s) 116 and dynamically update the remaining key term 402 rows with data 122. For instance, the data 122 may be displayed in the column named “Example 1.” In some examples, the user may change one or more of the key terms 402 via the user interface 400. In this example, user interface 400 may update the database footprint estimate 404 dynamically and in near real-time to reflect the changes made by the user 126. In some examples, user interface 400 may further include controls or selectable elements (not shown) to enable a user 126 to submit a database footprint estimate request.

User interface 400 further includes an exemplary database footprint estimate, represented as database footprint estimate 404, which includes outputs (illustrated as “Output-1”). The database footprint estimate 404 further includes cost estimates based on the database footprint, as well as potential cost avoidance 406 by archiving data.

In some examples, key terms 402 may be displayed as a first user interface and the database footprint estimate 404 may be displayed as a second, separate user interface. For instance, a user may submit the key terms 402 to the rapid database system 102 and, in response, the database footprint estimate 404 may be generated and displayed. As illustrated the database footprint estimate 404 includes outputs generated using the techniques described herein. In addition to displaying some of the key terms 402, the database footprint estimate 404 may include a plurality of detailed information that is exposed and displayed to a user 126 in a way that is easily understandable. For instance, the database footprint estimate 404 includes and potential cost avoidance (annual) 406. Accordingly, the user interface 400 may provide a user 126 greater visibility into underlying factors providing footprint size/cost (potential cost avoidance 406) associated with a database, enabling the user 126 to take actions to reduce a database footprint, and leading to improved functioning of databases within a large organization. That is, by reducing space used by a database, mirrors of the database, etc., the techniques described herein enable organizations to more effectively manage database storage in a streamlined and cost-effective manner.

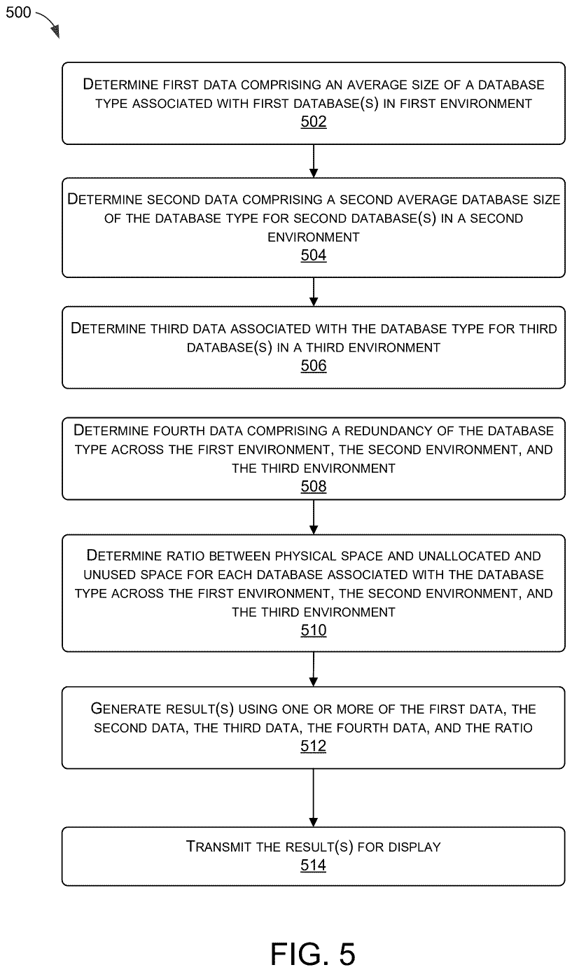

FIG. 5 is a pictorial flow diagram of an example process 500 according to the examples described herein. In examples, one or more operations of the process 500 may be implemented by a rapid database system, such as by using one or more of the components and systems illustrated in FIGS. 1-4 and described above and/or by using one or more of the components and systems illustrated in FIG. 6 and described below. One or more operations of the process 500 may be performed by a combination of components described in regard to these systems and/or other systems. However, the process 500 is not limited to being performed by such components and systems, and the components and systems described herein are not limited to performing the operations of the process 500.

At operation 502, the system may determine first data comprising an average size of a database type associated with first database(s) in a first environment. In some examples, the first data further comprises a frequency of the database type within the first environment. The database type may correspond to target 306 described in FIG. 3 above. For instance, the database type comprises one or more of a name associated with a particular database or a logical partition within one or more environments. The first environment may comprise a production environment, such as Environment A 110A, described in FIG. 1 above. In some examples, the system may determine the first data by querying, by the processor, the one or more first databases within the first environment and/or a mainframe of the first environment for respective database sizes; receiving, at the processor and from one or more database catalogs associated with each of the one or more first databases, respective database sizes for each of the one or more first databases; generating, by the processor and based on each of the respective database sizes, the average size; and outputting, by the processor and to a second processor of an integration engine of the rapid database system, the average size associated with the first environment. For instance, the integration engine may correspond to integration engine 216 described in FIG. 2.

At operation 504, the system may determine second data comprising a second average database size of the database type for one or more second databases in a second environment. In some examples, the second data further comprises a frequency of the database type within the second environment. In some examples, the second data comprises data determined and output by non-production module 204. The second environment may correspond to a non-production environment, such as Environment B 110B.

In some examples, the system may determine the second data by querying, by the processor, the one or more second databases within the second environment and/or a mainframe of the second environment for respective database sizes; receiving, at the processor and from one or more database catalogs associated with each of the one or more second databases, respective database sizes for each of the one or more second databases; generating, by the processor and based on each of the respective database sizes, the average size; and outputting, by the processor and to a second processor of an integration engine of the rapid database system, the average size associated with the second environment.

At operation 506, the system may determine third data associated with the database type for third database(s) in a third environment. In some examples, the second data further comprises a frequency of the database type within the third environment. For instance, the third environment may correspond to a development environment, such as Environment C 110C described herein. The system may determine the third data by querying, by the processor and using fuzzy logic, the one or more third databases for respective database sizes; receiving, at the processor and from one or more database catalogs associated with each of the one or more third databases, the respective database sizes; generating, by the processor and based on each of the respective database sizes, the average size; and outputting, by the processor and to a second processor of an integration engine of the rapid database system, the average database size associated with the third environment.

At operation 508, the system may determine fourth data comprising an indication of redundancy of the database type across the first environment, the second environment, and the third environment. For instance, the fourth data may be determined using the mainframe mirrors module 208. The fourth environment may correspond to a mainframe environment, such as Environment N 110N described herein.

The system may determine the fourth data by querying, by the processor, the first environment for first metadata indicating first redundancy within the first environment; receiving, at the processor and from the first environment, the first metadata; querying, by the processor, the second environment for second metadata indicating second redundancy within the second environment; receiving, at the processor and from the second environment, the second metadata; querying, by the processor, the third environment for third metadata indicating third redundancy within the third environment; receiving, at the processor and from the third environment, the third metadata; and generating, by the processor and based on aggregating the first metadata, the second metadata, and the third metadata, the fourth data; and outputting, by the processor and to a second processor of an integration engine of the rapid database system, the fourth data.

Additionally, or alternatively the system may determine the fourth data by querying, by the processor, a fourth environment for metadata indicating redundancy of the database type across the first environment, the second environment, and the third environment; receiving, at the processor and from the fourth environment, the metadata; generating, by the processor and based on the metadata, the fourth data; and outputting, by the processor and to a second processor of an integration engine of the rapid database system, the fourth data.

At operation 510, the system may determine a ratio between physical space and unallocated and unused space for each database associated with the database type across the first environment, the second environment, and the third environment. For instance, the system may determine the ratio using the mainframe ratio module described herein.

At operation 512, the system may generate result(s) using one or more of the first data, the second data, the third data, the fourth data, and the ratio. For instance, the system may generate the results data by correlating, by the processor and based on using a composite algorithm, the first data, the second data, the third data, the fourth data, and the ratio. In some examples, the system may generate the result(s) using integration engine 216. For instance, the system may utilize one or more algorithms, including the composite algorithm, machine learning algorithm, etc. to generate the results.

In some examples, the system may generate the result(s) data further using cost data. For instance, cost data may be input by a user via cost module 212 described herein. Cost data may comprise indications of a cost per raw unit of storage associated with a database type.

At operation 514, the system may transmit the result(s) for display. For instance, the system may transmit result data 124 to an application 120 and/or user device 118 for display via a user interface. As noted above, the results may include instructions to generate and display user interface 400 described in FIG. 4 herein.

FIG. 6 shows an example system architecture for a computing device 600 that may be implemented as (e.g., part of) any of the systems and devices described herein and/or may perform any of the operations and processes described herein. For example, the computing device 600 may represent any of the systems, devices, and components illustrated in FIG. 1. The computing device 600 may also represent any system configured to implement any of the signals and operations described in regard to FIGS. 2-5 and/or any other operation described herein. The computing device 600 may be a server, computer, mobile device (e.g., smartphone, smartwatch, laptop), or any other type of computing device that may execute any of the operations described herein. In some examples, operations as described herein may be distributed among and/or executed by multiple computing devices 600.

A computing device 600 can include memory 602. In various examples, the memory 602 can include system memory, which may be volatile (such as RAM), non-volatile (such as ROM, flash memory, etc.), or some combination of the two. The memory 602 may further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 600. Any such non-transitory computer-readable media may be part of the computing devices 600.

The memory 602 may include modules and data 604 needed to perform operations as described herein by one or more computing devices 600. Included with such modules and data 604 and/or also stored in the memory 602 may be a production module 620, a non-production module 622, development module 624, one or more mainframe modules 626, a cost module 628, and/or an integration engine. The production module 620 may perform any one or more of the operations related to sizing databases in a production environment (e.g., as described for production module 202 illustrated in FIG. 2). The non-production module 622 may perform any one or more of the operations related to sizing non-production databases as described herein (e.g., as described for non-production module illustrated in FIG. 2). The development module 624 may perform any one or more of the operations related to sizing databases in a development environment as described herein (e.g., as described for development module 206 illustrated in FIG. 2). The mainframe modules 626 may perform any one or more of the operations related to communicating, querying, and/or receiving data associated with a mainframe environment, as described herein (e.g., as described for mainframe mirrors module 208 and mainframe ratio module 210, illustrated in FIG. 2). The cost module 626 may perform any one or more of the operations related to determining cost information as described herein (e.g., as described for cost module 212 illustrated in FIG. 2). The integration engine 630 may perform any one or more of the operations related to generating result data and/or output as described herein (e.g., as described for integration engine 216 illustrated in FIG. 2).

One or more computing devices 600 may also have processor(s) 606, communication interface(s) 608, display(s) 610, output device(s) 612, input device(s) 614, and/or drive unit(s) 616 that may include one or more non-transitory and/or transitory machine-readable media 618.

In various examples, the processor(s) 606 can be a central processing unit (CPU), a graphics processing unit (GPU), both a CPU and a GPU, or any other type of processing unit. Each of the one or more processor(s) 606 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 606 may also be responsible for executing computer applications stored in the memory 602, which can be associated with common types of volatile (RAM) and/or nonvolatile (ROM) memory.

The communication interfaces 608 may include transceivers, modems, interfaces, antennas, telephone connections, and/or other components that can transmit and/or receive data over wired and/or wireless networks, telephone lines, and/or other connections.

The display(s) 610 can be any one or more of a liquid crystal display or any other type of display commonly used in computing devices. For example, the display(s) 610 may include a touch-sensitive display screen that may also act as an input device or keypad, such as for providing a soft-key keyboard, navigation buttons, and/or any other type of input.

The output device(s) 612 may include any sort of output devices known in the art, such as the display(s) 610, one or more speakers, a vibrating mechanism, and/or a tactile feedback mechanism. Output devices 612 may also include one or more ports for one or more peripheral devices, such as headphones, peripheral speakers, and/or a peripheral display.

The input device(s) 614 may include any sort of input devices known in the art. For example, input device(s) 614 may include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable media 618 of drive unit(s) 616 may store one or more sets of instructions, such as software or firmware, that embodies any one or more of the methodologies or functions described herein. The instructions can also reside, completely or at least partially, within the memory 602, processor(s) 606, and/or communication interface(s) 608 during execution thereof by the one or more computing devices 600. The memory 602 and the processor(s) 606 may also constitute machine-readable media 618.

With the techniques described herein, data received via, or otherwise associated with multiple communications channels may be more accurately associated with a particular context and more efficiently stored and provided for processing using an interaction interface. Furthermore, the communications channels may be changed while maintaining communications consistency with a user, thereby improving user satisfaction and increasing the efficiency of data collection and processing.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method of performing database sizing across dispersed environments, comprising:
identifying, by a processor, a database type associated with one or more databases in the dispersed environments;
determining, by the processor, first data indicating a first average database size of the database type in a first environment at a first location,
wherein the first environment comprises one or more first databases including first set of mirrors, wherein at least one mirror within the first set of mirrors comprises a copy of a database of the database type;
determining, by the processor, second data indicating a second average database size of the database type in a second environment at a second location, the second environment being different from the first environment,
wherein the second environment comprises one or more second databases including a second set of mirrors;
determining, by the processor, third data associated with the database type for one or more third databases in a third environment at a third location;
determining, by the processor and based in part on the first data, the second data, and the third data, fourth data identifying redundant copies of databases of the database type across the first environment, the second environment, and the third environment, the redundant copies including the at least one mirror;
determining, by the processor and based in part on the fourth data, a ratio between physical space and unused space for individual databases of the database type;
generating, by the processor and based on the first data, the second data, the third data, the fourth data, and the ratio, result data comprising:
a database footprint estimate indicative of a size of computer memory occupied by the database type across the first environment, the second environment, and the third environment, and
instructions to generate a user interface; and
transmitting, by the processor, the result data to a user device for display via the user interface.

2. The method of claim 1, wherein determining the first data comprises:
querying, by the processor, the one or more first databases for a database size;
receiving, at the processor and from one or more database catalogs associated with each of the one or more first databases, respective database sizes for each of the one or more first databases; and
determining, by the processor and based on the respective database sizes, the first average database size.

3. The method of claim 1, wherein determining the second data comprises:
querying, by the processor, the one or more second databases for a database size;
receiving, at the processor and from one or more database catalogs associated with each of the one or more second databases, respective database sizes for each of the one or more second databases; and
determining, by the processor and based on the respective database sizes, the second average database size.

4. The method of claim 1, wherein determining the third data comprises:
querying, by the processor and using fuzzy logic, the one or more third databases for respective database sizes;
receiving, at the processor and from one or more database catalogs associated with each of the one or more third databases, the respective database sizes; and
generating, by the processor and based on the respective database sizes, a third average database size.

5. The method of claim 1, wherein determining the fourth data comprises:
querying, by the processor, the first environment for first metadata indicating first redundancy within the first environment;
receiving, at the processor and from the first environment, the first metadata;
querying, by the processor, the second environment for second metadata indicating second redundancy within the second environment;
receiving, at the processor and from the second environment, the second metadata;
querying, by the processor, the third environment for third metadata indicating third redundancy within the third environment;
receiving, at the processor and from the third environment, the third metadata; and
determining, by the processor and based on aggregating the first metadata, the second metadata, and the third metadata, the fourth data.

6. The method of claim 1, wherein determining the fourth data comprises:
querying, by the processor, a fourth environment for metadata indicating redundancy of the database type across the first environment, the second environment, and the third environment;
receiving, at the processor and from the fourth environment, the metadata; and
determining, by the processor and based on the metadata, the fourth data.

7. The method of claim 1, wherein generating the result data comprises correlating, by the processor and based on using a composite algorithm, the first data, the second data, the third data, the fourth data, and the ratio.

8. The method of claim 1, wherein the first environment, the second environment, and the third environment each correspond to different geographical locations.

9. The method of claim 1, wherein the database type comprises one or more of a name associated with a particular database or a logical partition associated with one or more environments.

10. (canceled)

11. A non-transitory computer-readable medium comprising instructions that, when executed by one or more processors of a database system, cause the one or more processors to:
identify an input comprising an indication of a database type corresponding to a target database or a target logical partition across a plurality of environments;
determine, based in part on the input, first data indicating a first average database size of the database type in a first environment of the plurality of environments,
wherein the first environment comprises one or more first databases including a first set of mirrors;
determine second data indicating a second average database size of the database type in a second environment of the plurality of environments,
wherein the second environment comprises one or more second databases including a second set of mirrors;
determine third data associated with the database type for one or more third databases in a third environment of the plurality of environments;
determine, based in part on the first data, the second data, and the third data, fourth data associated with a fourth environment, the fourth environment comprising a mainframe environment that includes the first environment, the second environment, and the third environment,
wherein the fourth data indicates a redundancy associated with the database type in the fourth environment;
generate, based on the first data, the second data, the third data, and the fourth data, result data comprising:
a database footprint estimate indicative of a size of computer memory occupied by the database type across the plurality of environments, and
instructions to generate a user interface; and
transmit the result data to a user device for display via the user interface.

12. The non-transitory computer-readable medium of claim 11, wherein the fourth data further comprises a ratio between physical space and unused space for each database of the database type across the first environment, the second environment, and the third environment.

13. The non-transitory computer-readable medium of claim 11, wherein the mainframe environment includes metadata associated with a plurality of databases, the plurality of databases including a plurality of mirrors, including the first set of mirrors and the second set of mirrors.

14. The non-transitory computer-readable medium of claim 11, wherein generating the result data comprises correlating, based on using one or more algorithms, the first data, the second data, the third data, and the fourth data.

15. The non-transitory computer-readable medium of claim 11, wherein the result data further comprises one or more of:
an indication of a reduction in the database footprint estimate over a previous database footprint size,
a potential cost savings value, or
a cost associated with maintaining the database type across the plurality of environments.

16. A database storage system comprising:
one or more processors; and
a non-transitory memory storing computer-executable instructions that, when executed, cause the one or more processors to perform operations comprising:
identify a database type associated with one or more databases of the database storage system;
determine first data indicating a first average database size of a database type in a first environment at a first location,
wherein the first environment comprises one or more first databases including a first set of mirrors, wherein at least one mirror within the first set of mirrors comprises a copy of a database of the database type;
determine second data including a second average database size of the database type in a second environment at a second location,
wherein the second environment comprises one or more second databases comprising a second set of mirrors;
determine third data associated with the database type for one or more third databases in a third environment at a third location;
determine, based in part on the first data, the second data, and the third data, fourth data identifying redundant copies of databases of the database type across the first environment, the second environment, and the third environment, the redundant copies including the at least one mirror;
determine, based in part on the fourth data, a ratio between physical space and unused space for individual databases of the database type across the first environment, the second environment, and the third environment;
generate, based on the first data, the second data, the third data, the fourth data, and the ratio, result data comprising a database footprint estimate, the database footprint estimate indicative of a size of computer memory occupied by the database type across the first environment, the second environment, and the third environment; and
transmit the result data to a user device for display via a user interface.

17. The database storage system of claim 16, wherein the operations to determine the first data further comprise:
querying the one or more first databases for a database size;
receiving, from one or more database catalogs associated with each of the one or more first databases, respective database sizes for each of the one or more first databases; and
generating, based on the respective database sizes, the first average database size.

18. (canceled)

19. (canceled)

20. A system for generating a database footprint estimate, the system comprising:
means for determining first data indicating a first average size of a database type in a first environment at a first location,
wherein the first environment comprises one or more first databases including a first set of mirrors, wherein at least one mirror within the first set of mirrors comprises a copy of a database of the database type;
means for determining second data indicating a second average database size of the database type in a second environment at a second location, the second environment being different from the first environment,
wherein the second environment comprises one or more second databases including a second set of mirrors;
means for determining third data associated with the database type for one or more third databases in a third environment at a third location;
means for determining fourth data associated with a fourth environment comprising a mainframe environment that includes the first environment, the second environment, and the third environment, the fourth data identifying redundant copies of the database type;
means for generating, based on one or more of the first data, the second data, the third data, and the fourth data, result data comprising the database footprint estimate.
wherein the database footprint estimate is indicative of a size of computer memory occupied by the database type in the fourth environment; and
means for transmitting the result data to a user device for display via a user interface.

21. The method of claim 1, wherein the result data is generated as an output of a machine-learned model trained on a training data comprising historical data including previous database footprints.

22. The non-transitory computer-readable medium of claim 11, wherein the plurality of environments includes one or more of a production environment, a non-production environment, or a development environment.

23. The database storage system of claim 16, wherein the operations further comprise:
outputting, to a second processor of an integration engine of the database storage system, the first average database size and the second average database size.
